(19) United States
(12) Patent Application Publication
(10) Pub. No.: US 2015/0041511 A1
(43) Pub. Date: Feb. 12, 2015

(54) Compartmentalized Backpack with Imbedded Tracker Device

(71) Applicant: Dennis Powell, Belle Glade, FL (US)

(72) Inventor: Dennis Powell, Belle Glade, FL (US)

(21) Appl. No.: 14/445,615

(22) Filed: Jul. 29, 2014

Related U.S. Application Data
(60) Provisional application No. 61/864,291, filed on Aug. 9, 2013.

(51) Int. Cl. A45F 3/04; G08B 21/02

(52) U.S. Cl. CPC A45F 3/04; G08B 21/0269
USPC 224/576

(57) ABSTRACT

A backpack that has an outward appearance of a stuffed character, while providing an imbedded tracker device to monitor the location of a child. The backpack includes a main compartment, adjustable straps, and one or more small compartments. The exterior surface of the main compartment is adapted to repel water and illuminate in low light environments. The interior surface of the main compartment includes an insulated lining with pockets. The upper end of the main compartment includes a Global Positioning System (GPS) tracking unit therein. The GPS tracking unit is adapted to communicate with a server and a GPS satellite to disclose the location of a child that is carrying the backpack. The small compartments are adapted to store emergency supplies such as a first aid kit and an emergency contact card. In this way, the present invention facilitates parents and guardians in supervision and monitoring of a child.

### CROSS REFERENCE TO RELATED APPLICATION

This application claims the benefit of U.S. Provisional Application No. 61/864,291 filed on Aug. 9, 2013. The above identified patent application is herein incorporated by reference in its entirety to provide continuity of disclosure.

### BACKGROUND OF THE INVENTION

1. Field of the Invention

The present invention relates to a backpack with an imbedded tracking device for children. More specifically, the present invention pertains to an ornamental backpack with a plurality of compartments that are adapted to enclose school supplies, a tracking device, and emergency supplies such as an emergency contact card and a first aid kit. The device further comprises insulated pockets for storing food and beverages.

There are various types of support services needed to provide proper supervision of children, especially those who are prone to health risks or have special needs. It is difficult to supervise children when they do not stay in one place, as many children travel from school, extracurricular activities, social activities, and even friends' homes throughout the day. Additionally, it is difficult to locate children when they leave a designated area. When children venture out alone, they may get lost and become vulnerable to abduction. This is particularly problematic when a child suffers from a mental illness or a mental health disorder such as autism, or other cognitive disability, as the child may pose a threat to himself or herself or to others.

For the foregoing reasons, a locator device for children can be a valuable asset for any parent or guardian. The present invention is a compartmentalized backpack with imbedded tracking device. The tracking device may automatically provide real-time updates of the location of the child over the Internet. Accordingly, the user may check the location of the person from any electronic device having an Internet connection. In this way, the present invention can improve child safety.

The primary advantage of the present invention is not only its tracking capability, but more specifically the organizational compartments of the backpack. The backpack is designed to appeal to children, and it is convenient to carry to school and various activities. The compartments may be used to store school supplies, as well as emergency supplies such as an emergency contact card and first aid kit. Additionally, the interior of the bag is lined with an insulated liner to keep food and beverages at a cool temperature. In this way, the present invention serves multiple purposes while providing a bag that can be used to carry loads or any sort of equipment.

2. Description of the Prior Art

Devices have been disclosed in the prior art that relate to locators and monitoring systems for use with children, as well as character backpacks for children. These include devices that have been patented and published in patent application publications. Some of these patents describe a personal security system that comprises a portable device that is adapted to be carried by a child. Such devices comprise imbedded electrical components that facilitate interacting with the child and determining the location of the child.

Other patents describe a backpack that resembles a stuffed animal or character. These devices, however, do not include a backpack with imbedded GPS tracking unit and that further includes multiple compartments for storing school supplies and emergency supplies therein. The following is a list of devices deemed most relevant to the present disclosure, which are herein described for the purposes of highlighting and differentiating the unique aspects of the present invention, and further highlighting the drawbacks existing in the prior art.

For example, U.S. Pat. No. 7,248,170 to DeOme discloses an interactive personal security system comprising a portable device in the form of a toy with imbedded electrical components therein. The electrical components may include a microphone, video cameras, a distance sensor, a timer, speakers, a motion sensor, a tracking transponder, a receiver, a transmitter, memory, a database, and a power source. The device is adapted to record and recognize voices and images of people who are near the device. The device is further adapted to communicate with a child and to disclose the location of the child. While the device of DeOme discloses a GPS tracking unit that is imbedded in an item that appeals to children, DeOme does not disclose a backpack with multiple compartments thereon. As such, the DeOme device does not allow children to carry loads or other equipment in a convenient manner. In contrast, the present invention discloses a backpack with insulated interior lining and imbedded GPS tracking unit. The backpack has an outer appearance of a character, which is aesthetically pleasing to children while providing safety features to be utilized as desired.

Another device, U.S. Published Patent Number 2012/0329358 to Cupid discloses a stuffed toy, blanket, and backpack combination device. The stuffed toy comprises two straps, and a middle portion that is adapted to receive a folded or rolled up blanket therein. The purpose and design of the Cupid device, however, differ from the present invention in that the purpose of the Cupid device is to allow a child to easily carry a blanket by transporting it in the stuffed toy that functions as a backpack. In contrast, the purpose of the present invention is to provide an ornamental backpack that can be utilized on a daily basis to track the location of a child and to equip the child with emergency supplies when needed. Accordingly, the device of Cupid is not designed to provide such functionalities.

Similarly, U.S. Pat. No. 4,662,550 to O'Donnell discloses a backpack that is attached to a stuffed animal or a doll. When worn, the arms and legs of the stuffed animal or doll function as two straps that go over the shoulders. In this regard, among other features, O'Donnell does not disclose a compartmentalized backpack with an imbedded tracking device. Additionally, O'Donnell does not disclose insulated lining in the interior of the backpack. In contrast, the present invention provides multiple compartments for storing various items therein. Without limitation, the present invention is adapted to store a GPS tracking unit, school supplies, emergency supplies, food and beverage. Each of the compartments are constructed to store items of different sizes. For instance, the present invention comprises separate compartments for storing writing utensils, books, and a first aid kit, among other things.

U.S. Published Patent Application Number 2013/0084551 to Houston discloses a child learning and safety device comprising a housing that is attached to a strap system. The housing is constructed to enclose an audio device, a speaker assembly, a location processor, and one or more location sensors. The location sensor is adapted to activate an alarm when the device leaves a designated area. The strap system may be used to secure the device onto a body part of a child. In this regard, Houston fails to disclose a backpack. The present invention comprises a backpack that is designed to be utilized for tracking the location of a child who is using the backpack.

Finally, U.S. Design Pat. No. D313,118 to Maddocks discloses a child's carrying case that is in a shape of an animal. In particular, the case comprises two halves wherein a first half resembles a front of a dog and a second half resembles a back of the dog. The two halves are joined along a lower portion via a hinge. An upper portion of the second half comprises a handle that extends outwardly therefrom. While the device of Maddocks discloses a bag, it does not disclose multiple compartments therein. Additionally, the interior of the Maddocks device does not include an insulated lining. Thus, the Maddocks device is not suitable to store food or beverage therein. Moreover, the Maddocks device does not disclose a GPS tracking unit. The present invention, however, provides a backpack that can be used to locate a child, thereby increasing the versatility of the backpack by providing one that can be utilized for different purposes.

These prior art devices have several known drawbacks. The prior art devices fail to disclose a GPS tracking unit that is imbedded within a backpack having multiple compartments. The present invention discloses a backpack with an imbedded tracking device. The backpack may be in the form of a character that appeals to children of all ages. The tracking device may be powered via an internal power source, such as a rechargeable battery. The compartments may be used to carry various items therein, and allows a child to be well-equipped with various emergency supplies such as an emergency contact card and a first aid kit. It is therefore submitted that the present invention substantially diverges in design elements from the prior art, which overcomes the disadvantages of the prior art devices, and consequently it is clear that there is a need in the art for an improvement to existing locators and monitoring systems for use with children. In this regard the instant invention substantially fulfills these needs.

### SUMMARY OF THE INVENTION

In view of the foregoing disadvantages inherent in the known types of locators and monitoring systems for use with children, as well as character backpacks for children now present in the prior art, the present invention provides a new improvement to compartmentalized backpacks with an imbedded tracker device wherein the same can be utilized for determining the location of a child and carrying various items therein.

It is therefore an object of the present invention to provide a new and improved compartmentalized backpack with an imbedded tracker device that has all of the advantages of the prior art and none of the disadvantages.

It is another object of the present invention to provide a new and improved compartmentalized backpack with an imbedded tracker device that is in the form of a stuffed animal or a character that is appealing to children of all ages.

Another object of the present invention is to provide a new and improved compartmentalized backpack with an imbedded tracker device having a GPS tracking device that allows a parent or a guardian to receive information about a child's location.

Yet another object of the present invention is to provide a new and improved compartmentalized backpack with an imbedded tracker device having multiple compartments to store and carry various items therein.

Still yet another object of the present invention is to provide a new and improved compartmentalized backpack with an imbedded tracker device that allows a parent or a guardian to equip a child with emergency supplies.

Still yet another object of the present invention is to provide a new and improved compartmentalized backpack with an imbedded tracker device that includes insulated lining to help keep food and beverage cool within the compartment of the backpack.

Still yet another object of the present invention is to provide a new and improved compartmentalized backpack with an imbedded tracker device that is highly visible in low light environments.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and in manner in which it may be made and used may be better understood after a review of the following description, taken in connection with the accompanying drawings wherein like numeral annotations are provided throughout.

FIG. 1 shows a front perspective view of an embodiment of the present invention.

FIG. 2 shows a rear perspective view of an embodiment of the present invention.

FIG. 3 shows a view of an embodiment of the present invention in an open configuration.

FIG. 4 shows a schematic diagram of the GPS tracking unit of the present invention.

### DETAILED DESCRIPTION OF THE INVENTION

Reference is made herein to the attached drawings. Like reference numerals are used throughout the drawings to depict like or similar elements of the compartmentalized backpack with imbedded tracker device. For the purposes of presenting a brief and clear description of the present invention, the preferred embodiment will be discussed as used for utilized for determining the location of a child and carrying various items therein. The figures are intended for representative purposes only and should not be considered to be limiting in any respect.

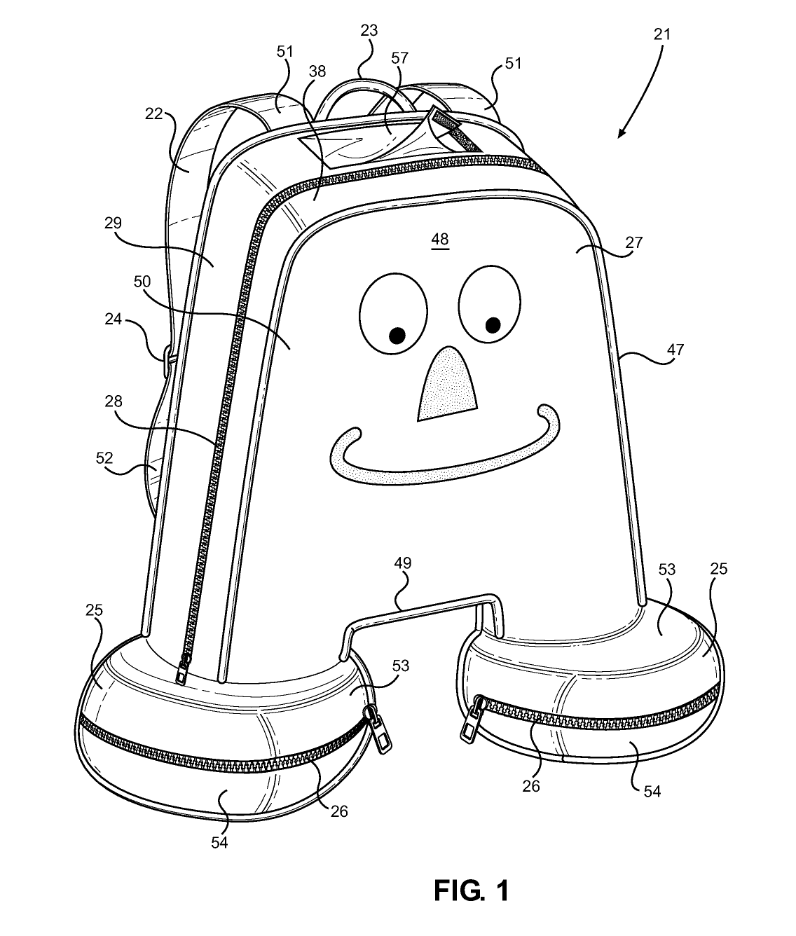

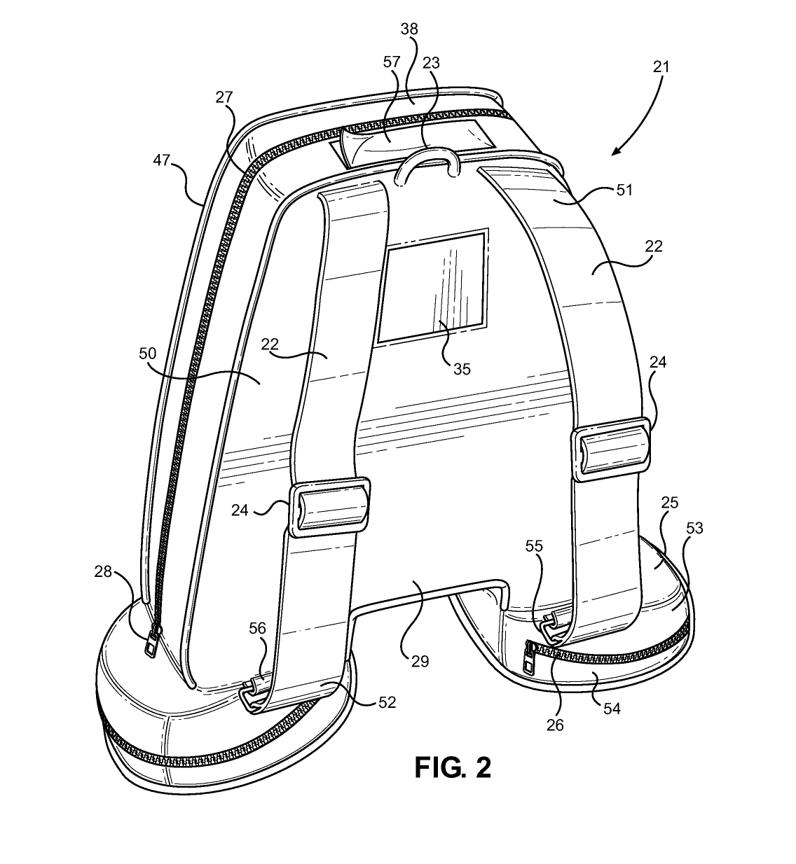

Referring now to FIGS. 1 and 2, there are shown front and rear perspective views of an embodiment of the present invention, respectively. The present invention comprises a generally A-shaped backpack 21 with a main compartment 50 and one or more lower compartments 25. In the illustrated embodiment, the exterior surface 48 of the backpack 21 is composed of soft fabric such as soft fleece or plush material so as to resemble a stuffed toy. It is preferred that the exterior surface 48 of the backpack 21 may also be treated to repel water so that the backpack 21 is substantially water-resistant. In some embodiments, the exterior surface 48 of the backpack 21 may comprise a material or fabric that glows or illuminates in low light environments to increase visibility of the backpack 21. Alternatively, the exterior surface 48 of the backpack 21 may comprise a highly reflective material or fabric as an added safety feature. In the illustrated embodiment, the backpack 21 comprises a reflective piping 47 along the periphery of the main compartment 50 and the lower compartments 25.

The main compartment 50 includes an openable upper end 38 and a closed lower end 49. Additionally, the main compartment 50 includes a front side 27 that is connected to a back side 29 at the lower end 49. The main compartment 50 further includes a zipper 28 between the front side 27 and the back side 29, which provides access to an interior volume therebetween. An exterior of the front side 27 comprises a variety of designs that appeal to children. In the illustrated embodiment, the front side 27 comprises a face of a character. In this way, the backpack 21 of the present invention resembles a stuffed character.

The main compartment 50 further includes an exterior pocket 57 on the upper end 38. The exterior pocket 57 may be rectangular in shape and is dimensioned to hold a GPS tracking unit therein. The exterior pocket 57 may be composed of same material as the exterior surface 48 so as to blend in with the rest of the backpack 21. The pocket 57 comprises a first side opposite a second side, and a third side opposite a fourth side. The first, third, and fourth sides may be stitched onto the upper end 38 of the main compartment 50, leaving the second side open. The second side of the exterior pocket 57 may open and close via hook and loop fasteners or other suitable closure.

The back side 29 includes a handle 23 attached at the upper end 38 of the backpack 21. The handle 23 is composed of woven nylon or other suitable material. Each of the terminal ends of the handle 23 is sewn onto the upper end 38 of the back side 29 so as to form a closed loop. The handle 23 may be used for hanging the backpack 21 or for carrying. Additionally, the back side 29 includes a tag 35 for displaying the backpack owner's information. The tag 35 is generally rectangular in shape with a perimeter that is sewn onto the back side 29. Alternatively, the tag 35 may comprise other shapes, designs, and colors. The tag 35 may comprise a writable surface so that the backpack owner can write the name, address, and phone number of a person to be contacted in case the backpack 21 is lost and found.

The back side 29 further comprises a pair of adjustable straps 22, wherein the straps 22 are composed of woven nylon or other suitable material. The first ends 51 of the straps 22 are secured near the upper end 38 of the back side 29 and the second ends 52 of the straps 22 are secured near the lower end 49 of the back side 29. In the illustrated embodiment, the first ends 51 of the straps 22 are sewn onto the back side 29 of the backpack 21. The second ends 52 of the straps 22 are threaded through a ring 55 and folded onto itself to form a closed loop. Each of the rings 55 is sewn onto a closed loop 56 disposed near the lower end 49 of the back side 29. Each of the straps 22 are adjustable via a buckle 24, wherein each of the straps 22 are threaded through the respective buckle 24. In some embodiments, the straps 22 may further include padding thereon to make the straps 22 more comfortable to the user. The padding may comprise an enclosure with an interior volume having cushioning therein. The enclosure may be composed of durable and breathable fabric such as nylon and mesh, and the cushioning may be composed of gel material or foam pad.

The backpack 21 further comprises lower compartments 25 that are disposed near the lower end 49 of the main compartment 50. Each of the lower compartments 25 is generally round in shape and comprises a top portion 53, a bottom portion 54, and a zipper 26, which provides access to an interior volume therein. In the illustrated embodiment, the lower compartments 25 resemble a character's feet. The lower compartments 25 are preferably smaller in dimension compared to the main compartment 50 and are constructed so that it is suitable for storing smaller items such as keys or a wallet.

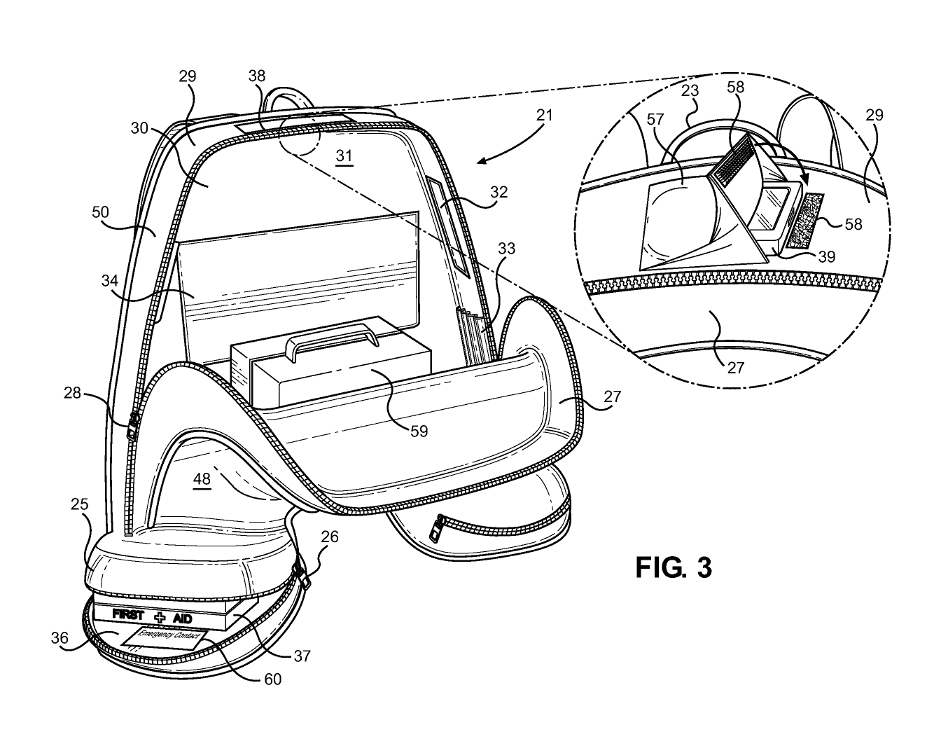

Referring now to FIG. 3, there is shown a view of an embodiment of the present invention in an open configuration. The main compartment 50 and the lower compartments 25 comprise a zipper 28 and 26, respectively. Each of the zipper 28 and 26 may be water-resistant or may be composed of material such as plastic. The zipper 28 comprises a first and second zipper chain, wherein the first zipper chain is attached to the front side 27 and the second zipper chain is attached to the back side 29. The first and second zipper chains extend from one side of the main compartment 50 to the opposite side of the main compartment 50. The zipper chains include a stop that is adapted to maintain a zipper slider. The first zipper chain includes a retainer box and the second zipper includes an insertion pin adapted to connect to the retainer box on the first zipper chain. The zipper slider is adapted to bring the first and second zipper chains together or separate the chains, thereby closing and opening the main compartment 50, respectively. When the zipper slider separates the first and second zipper chains, the front 27 and back 29 sides separate to expose the interior volume 30 of the main compartment 50.

Similarly, the zipper 26 comprises a first and second zipper chain, wherein the first zipper chain is attached to the top portion 53 and the second zipper chain is attached to the lower portion 54. The zipper slider is adapted to bring the first and second zipper chains together or separate the chains, thereby closing and opening the lower compartment 25, respectively. When the zipper slider separates the first and second zipper chains, the top 53 and bottom 54 portions separate to expose the interior volume 36 of the lower compartment 25.

The interior volume 30 of the main compartment 50 is dimensioned to fit school supplies such as books and notebooks therein. The interior surface 31 of the main compartment is substantially coextensive with the exterior surface 48 of the main compartment 50. In one embodiment, the interior surface 31 of the main compartment 50 is lined with insulated liner, which may be composed of insulating fabric such as polyester and vinyl. The insulating liner helps to keep beverage and food cold for an extended period of time.

Alternatively, the main compartment 50 may further include a lunch box 59 for storing beverage and food therein. In one embodiment, the lunch box 59 is removably attached to the interior of the main compartment 50. The lunch box 59 may comprise a rigid construction to help protect the beverage and food from crushing against school supplies stored in the interior volume 30 of the main compartment 50. The lunch box 59 may comprise insulated lining to help keep beverage and food cold for an extended period of time. Additionally, the lunch box 59 may be water resistant so that it is protected from spills.

Additionally, the interior surface 31 of the main compartment 50 comprises one or more pockets to help organize the items contained therein. For example, rectangular pockets 32, 34 may be used to store a student's school ID, lunch card, or small note pads. Another pocket 33 may comprise a plurality of openings for receiving writing utensils therein. Alternatively, items may be stored in the interior volume 36 of the lower compartments 25. In a preferred embodiment, the interior volume 36 of one of the lower compartments 25 is adapted for storage of emergency supplies such as a first aid kit 37 or an emergency contact card 60. In this way, a child is equipped with emergency supplies at all times when carrying the backpack 21 of the present invention.

The emergency contact card 60 may include personally identifiable information and personal medical information of the child. The personally identifiable information may include name, date of birth, sex, address of home of record, phone number, among other things. Additionally, personal medical information may include relevant medical information of the child, such as the child's blood type, allergies, medical diseases and conditions, medical doctor contact information, and the like. The medical information allows emergency medical personnel accommodate to the medical needs of the child in cases of emergency. Furthermore, the emergency contact card 60 may include information relating to the child's parent or guardian, such as the name, phone number, and address of the parent or guardian to be contacted in case of emergency.

The backpack 21 further includes a GPS tracking unit 39 that is stored inside the exterior pocket 57 on the upper end 38 of the backpack. The pocket 57 comprises a hook and loop fastener 58 so as to secure the GPS tracking unit 39 inside of the pocket 57. The GPS tracking unit 39 preferably comprises a housing member with necessary internal circuitry therein. The housing member of the GPS tracking unit 39 is lightweight and small in size so that it is portable and easy to carry. The GPS tracking unit 39 allows a parent or guardian of a child to locate the child by detecting the signal of the GPS tracking unit 39 in the backpack 21 that is carried by the child. In a preferred embodiment, the GPS tracking unit 39 further comprises a charging unit so as to allow the parent or guardian to charge the GPS tracking unit 39 daily to ensure that there is sufficient power before each use.

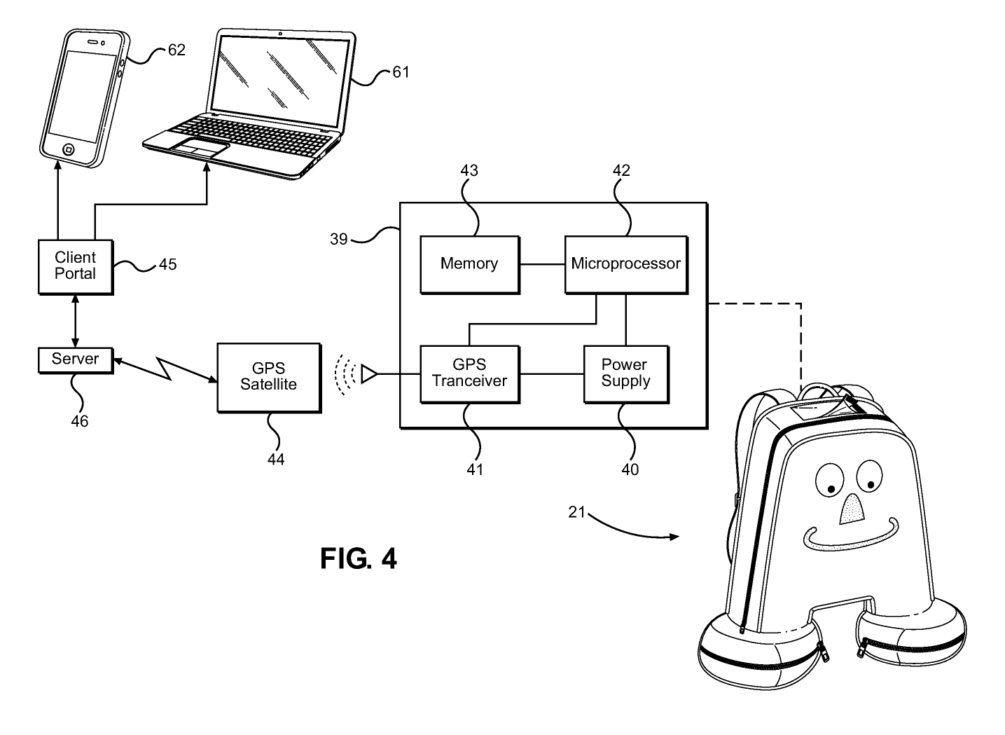

Referring now to FIG. 4, there is shown a schematic diagram of the present invention. The GPS tracking unit 39 includes a GPS transceiver 41, microprocessor 42, and memory 43. The GPS tracking unit 39 is powered internally via a rechargeable battery or other suitable power supply 40. The power supply 40 may be charged via a charging unit. Additionally, the power supply 40 may be rechargeable or replaced as needed by the user. The GPS transceiver 41, microprocessor 42, and memory 43 are electronically interconnected so that they are considered to be indivisible for the purposes of construction.

The GPS transceiver 41 is adapted to communicate with a GPS satellite 44. More specifically, the GPS transceiver 41 transmits an outgoing signal to the GPS satellite 44. Radio waves propagate a given distance during this transmission and are received by the GPS satellite 44. Once the outgoing transmission initiates, the time of transmission is marked by the microprocessor 42. The GPS satellite 44 accepts the incoming transmission from the GPS transceiver 41 of the present invention and sends a signal to back to the GPS transceiver 41. Thereafter, the GPS transceiver 41 receives an incoming signal from the GPS satellite 44. When the incoming transmission terminates, the time of receipt is marked by the microprocessor 42. The microprocessor 42 is adapted to interpret incoming signals, make calculations based on input information, and thereafter determine output information. Accordingly, the microprocessor 42 uses the time of transmission and the time of receipt to calculate the distance and direction between GPS satellite 44 and the GPS tracking unit 39. Because the GPS tracking unit 39 is attached to the backpack 21 that is carried or worn by a child, locating the backpack 21 allows a parent or guardian to locate the child.

The GPS satellite 44 is adapted to communicate with a computerized system server 46 on the ground. In other embodiments, the GPS satellite 44 may transmit signals to a satellite tower or an antenna tower of a ground station, wherein the ground station can communicate with the computerized system server 46. The computerized system server 46 is adapted to communicate with a client portal 45 via the Internet and/or a local area network (LAN).

The client portal 45 is accessible by the parent or guardian who is supervising the child. The parent or guardian may access the client portal 45 by logging onto a website or a webpage. In this way, the parent or guardian may access the client portal 45 from any electronic device having web-browsing capabilities, which provides convenience to the parent or guardian. For instance, the parent or guardian may access the client portal 45 via a computer 61 or a hand held device such as a smart phone 62. The website or the webpage may require the parent or guardian to register the GPS tracking unit 39 so that the parent or guardian may track the location of a particular child.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A child locator and monitoring device, comprising:
a backpack having a main compartment and at least one lower compartments attached to said main compartment;
wherein said backpack comprises a stuffed character exterior appearance;
said main compartment having an upper end, a lower end, front side, a back side, and an interior volume;
said at least one lower compartments having a top portion, bottom portion, and an interior volume;
at least one adjustable strap having a first end and a second end;
said first end of said at least one adjustable strap attached to said upper end;
said second end of said at least one adjustable strap attached to said lower end;
a GPS tracking unit removably secured within said upper end.

2. The child locator and monitoring device of claim 1, further comprising a zipper adapted to secure said front side to said back side.

3. The child locator and monitoring device of claim 1, further comprising a zipper between said top portion and said bottom portion of said at least one lower compartment.

4. The child locator and monitoring device of claim 1, further comprising a handle.

5. The child locator and monitoring device of claim 1, wherein an exterior surface of said backpack is composed of soft plush material.

6. The child locator and monitoring device of claim 1, wherein said backpack further comprises a reflective piping.

7. The child locator and monitoring device of claim 1, wherein said backpack further comprises an insulated interior lining.

8. The child locator and monitoring device of claim 1, wherein said main compartment further comprises a plurality of interior pockets.

9. The child locator and monitoring device of claim 1, wherein said back side further comprises a writable surface.

10. The child locator and monitoring device of claim 1, wherein said backpack is A-shaped.

11. The child locator and monitoring device of claim 1, wherein said backpack repels water.

12. The child locator and monitoring device of claim 1, wherein said GPS tracking unit comprises:
a GPS transceiver adapted to transmit an outgoing signal to a GPS satellite and receive an incoming signal from said GPS satellite;
a microprocessor adapted to interpret said incoming signal and said outgoing signal for calculation of a distance and a direction between said GPS satellite and said GPS tracking unit;
a memory; and
a power supply.

13. The child locator and monitoring device of claim 12, wherein said power supply is a rechargeable battery.

14. The child locator and monitoring device of claim 12, wherein:
said GPS satellite is adapted to communicate with a computerized system server;
said computerized system server is adapted to communicate with a client portal;
said client portal is accessible via a computer or a mobile electronic device.

15. The child locator and monitoring device of claim 1, further comprising an exterior pocket on said upper end;
said exterior pocket adapted to hold said GPS tracking unit therein.
